(19) United States
(12) Patent Application Publication
(10) Pub. No.: US 2014/0345418 A1
(43) Pub. Date: Nov. 27, 2014

(54) CONNECTING ROD OF RECIPROCATING COMPRESSOR

(71) Applicant: Raul Bosco Junior, Joinville (BR)

(72) Inventor: Raul Bosco Junior, Joinville (BR)

(73) Assignee: Whirlpool S.A, São Paulo- SP (BR)

(21) Appl. No.: 14/241,315

(22) PCT Filed: Aug. 15, 2012
(86) PCT No.: PCT/BR2012/000295

§ 371 Date: May 6, 2014

(30) Foreign Application Priority Data
Aug. 30, 2011 (BR) P11103745-8

(51) Int. Cl. F16C 7/02

(52) U.S. Cl. CPC F16C 7/023
USPC 74/579 R

(57) ABSTRACT

The present invention relates to a connecting rod for reciprocating compressor, in particular a connecting rod converting the crank rotating motion into linear axial motion. The rod (1) having means capable of compensate efforts and ensure alignment and deflection of the piston (P) inside the cylinder (C). Such means comprising at least two regions (5, 6) capable of oriented resilient deformation, being such regions (5, 6) formed in the body (2) and oriented in opposite directions.

### FIELD OF INVENTION

The present invention relates to a connecting rod for reciprocating compressor, in particular a connecting rod converting the circular rotational eccentric movement (motor shaft of the compressor) in axial linear movement (to the piston of the compressor). A concerned connecting rod comprises means for attenuation of friction in relation to the inner face of the compressor cylinder.

### BACKGROUND OF THE INVENTION

According to experts skilled in the art, it is known that a reciprocating compressor comprises a device capable of compressing certain volume of fluid through the volumetric change of a chamber where the fluid to be compressed is arranged inserted.

In this regard, a reciprocating compressor is formed by at least one piston-cylinder assembly, the cylinder comprises a camera capable of volumetric change, and the piston comprises means of volumetric change of the cylinder, i.e., the piston is designed to be axial and reciprocating moved inside the cylinder, increasing and decreasing its volume. Therefore, a fluid disposed inside the cylinder can be compressed. To this regard, the piston is trailered to a driving source (usually an electric motor) that can provide both linear and circular motion.

Conventionally, the piston is trailered to the actuating mean through a driving element extender/movement converter technically known as a connecting rod.

In the cases of linear actuating means (where the “movable part” from motor presents linear axial movement), a connecting rod comprises only an extension element of movement between the motor and the piston.

But in cases of circular motion actuating means (where the engine “rotor” provides circular rotational movement around its own axis), the connecting rod comprises the element responsible for converting the circular movement (from motor) into linear movement (to piston). In such cases the engine “rotor” presents an eccentric circular movement and is perpendicularly arranged relative to the direction of piston displacement.

Thus, the “rotor” of a compressor based on a circular movement actuating mean is physically associated with one end of the rod, and the other end of the connecting rod is physically associated with the piston. This assembly allows to eccentric rotation be converted into linear reciprocating motion.

Within this context, and in the case of compressors based on actuating mean with circular motion, there are known high-capacity compressors (known as hyper-static compressors) which rotor-connection rod association is bushed in at least two different points and parallel to the almost symmetrical axis of the piston rod. One of these bushing points comprises the inner part of the compressor block, and the other bushing point comprises a contact body arranged over the rotor-connection rod combination. In that constructivity large volumetric changes are generated inside the cylinder, such changes that at the time of maximum compression load impose a load-reactive association rotor-connecting rod. As this association is bushed in at least two different points and almost symmetrical, the reactive load does not cause further damage.

Also known are medium-capacity compressor (compressor known as “Cantilever”) which association rotor-connection rod is bushed in one or two points, in particular, but only inside the compressor block. This constructivity, volumetric changes generated in the cylinder is only average, after all, would cause large changes in size (at the time of maximum compression load) mechanical deformation of rod-rotor combination.

Thus, it is noted that the average capacity compressors have a maximum compression, which is usually related to the integrity of the rotor-connecting rod combination.

Under this scenario, it is observed that the current state of the art includes some solutions capable to increase at least in part, the maximum compressor average capacity. Some of these solutions are based on the constructivity of the connecting rod itself.

The document U.S. Pat. No. 6,272,971 discloses a connecting rod of a hermetic compressor capable of reducing the compressive stress between the motor rotor and the piston by a “deflection cut.” Besides the aforementioned “deflection cut” the concerned connecting rod further comprises a metal core with an adapted conformation that allows the relief distribution of compressive stress. In general, the connecting rod described in U.S. Pat. No. 6,272,971 comprises a connecting rod known as “symmetric rigid connecting rod”, which is unable to undergo any kind of deformation and/or bending.

The current state of the art also provides specially deformable connecting rods, which have a single point of controlled “bending”, usually in a single direction.

An example of such connecting rod is disclosed in U.S. Pat. No. 7,305,916, where a connecting rod is observed especially applied in a set of internal combustion engine comprising both a geometry and a positioning capable to compensating for positioning and bending deflection occurring during system operation. In this case, the geometry of the connecting rod provides a core metal made up of two sections of different thicknesses, and the difference in thickness is smoothed by a ramp, which requires some “flexibility” to the rod.

To emphasize that the connecting rod described in U.S. Pat. No. 7,305,916 provides a single point “flexible”, which can be bent only in one way.

Although this latter type of connecting rod enables a slight increase of compressor average capacity, due to the possibility of deformation by the compression reactive load (preventing the association data rotor-connection rod), it is noted that it presents a constructivity negative aspect of high relevance.

This negative aspect is related to the misalignment between the piston and cylinder caused by the deformation of oriented rod.

According to FIG. 1, it is possible to note that the connecting rod, when deformed interferes (even momentarily) in alignment between piston and cylinder. This misalignment (where at least one end of the piston is forced against the inner face of the cylinder) is very, detrimental to the life time of the compressor, as the “drag” between the piston and the cylinder causes thinning of the material and changes (over time) the hermetic sealing of the piston-cylinder assembly, thus reducing the efficiency of the compressor.

Based on all the context explained above, it remains obviously need to develop a solution that can alleviate or even eliminate, the negative aspects discussed above.

### Objects of the Invention

Therefore, it is one of the objects of the present invention to provide a reciprocating compressor connecting rod, made of integral body (monoblock), able to compensate every deflection effort occurring during compressor operation.

It is also another object of the present invention to provide a reciprocating compressor connecting rod which, in addition to compensate every deflection effort which occurs during compressor operation, also prevents misalignment between the piston and the inner surface of the cylinder.

Thus, it is also an object of the present invention to provide a reciprocating compressor connecting rod able to boost the compressor capacity, allowing, for example, compressors with a medium-capacity constructivity aspects act as high-capacity compressors with similar capacities.

### SUMMARY OF THE INVENTION

These and other objects of the invention disclosed herein are fully achieved by the connecting rod for reciprocating compressor disclosed herein, which converts a circular movement of an eccentric shaft into reciprocating linear movement to a piston. The said connecting rod comprises a first connecting end and a second connecting end, both physically associated with a body.

The concerned connecting rod provides for means capable to compensate deflection efforts and ensure alignment of the piston inside the cylinder, such means comprising at least two regions liable to oriented resilient deformation. The above regions capable of oriented resilient deformation are formed in the body and are capable of oriented resilient deformation in opposite directions.

Preferably, each of regions capable of resilient deflection is located at one of body distal ends. Specifically, each of regions capable of oriented resilient deflection is located between one of the distal ends of the body and its said end connection.

According to the concepts of the present invention, the oriented resilient deformation regions comprises, each of them, a bend or relief area formed in the body.

In this regard, at least one of regions capable of suffering oriented resilient deformation has its apex oriented vertically upwards, and at least one of regions capable of suffering resilient deformation has its apex oriented vertically downwards.

### BRIEF DESCRIPTION OF FIGURES

The present invention will be described in detail based on the following figures listed below, in which:

FIG. 1 illustrates, schematically, a conventional application of a connecting rod according to the current state of the art;

FIG. 2 illustrates, schematically, the performance (in maximum compression load) of a connecting rod according to the current state of the art;

FIG. 3 illustrates a first example of a reciprocating compressor connecting rod herein disclosed, side view;

FIG. 4 shows a side cut of the connecting rod illustrated in FIG. 3;

FIG. 5 illustrates a second example of the reciprocating compressor connecting rod herein disclosed, side view;

FIG. 6 illustrates a third example of the reciprocating compressor connecting rod herein disclosed, side view;

FIG. 7 illustrates, schematically, when the connecting rod hereof is in minimum compression load, and

FIG. 8 illustrates, schematically, when the connecting rod hereof is in maximum compression load.

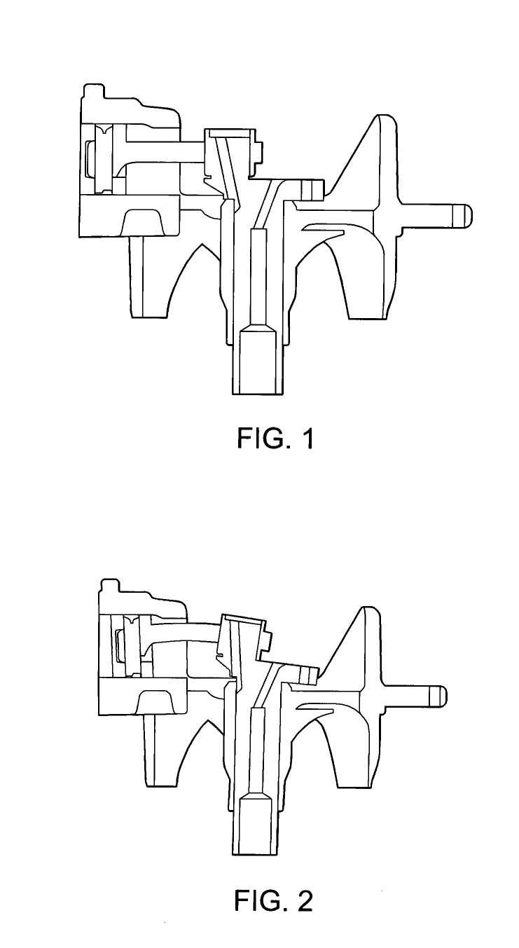

### DETAILED DESCRIPTION OF THE INVENTION

According to the concepts and motivation of the invention, there is disclosed a connecting rod for reciprocating compressor provided with means able to compensate for deflection effort and ensuring the alignment of its piston inside the compressor cylinder. This connecting rod allows, thus, the wear reduction between the piston and the inner face of the cylinder, which at the end increases significantly, the reliability of the compressor.

Preferably, the reciprocating compressor connecting rod (hereinafter referred just as rod) comprises a rod capable of converting a circular motion from an eccentric axis EE into a reciprocating linear motion to the piston P.

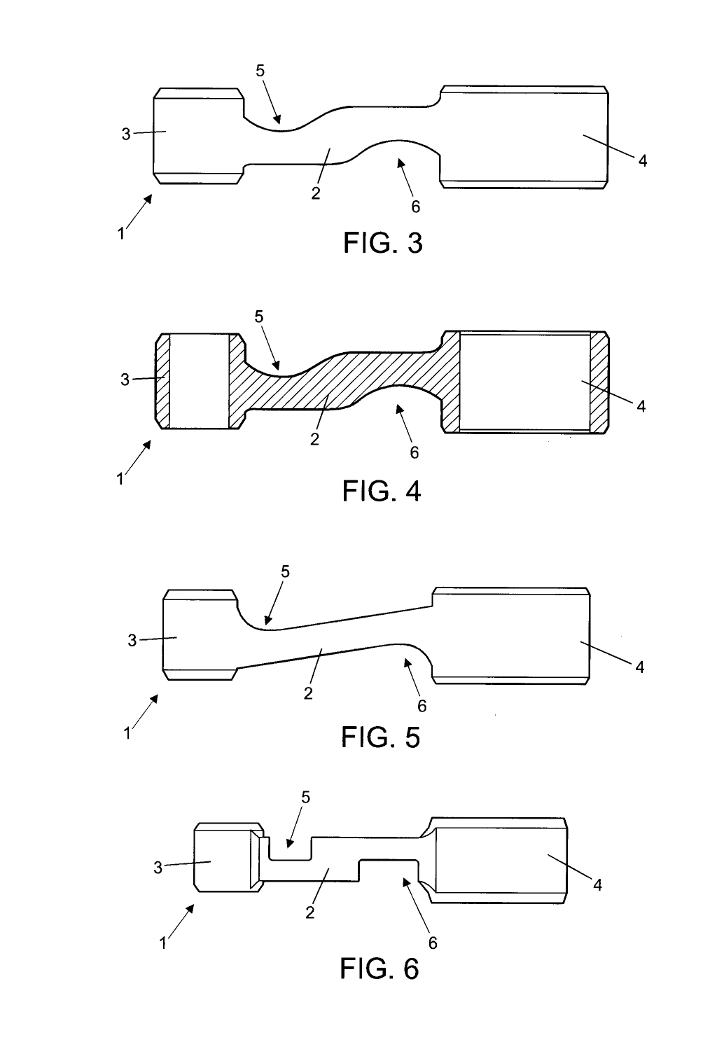

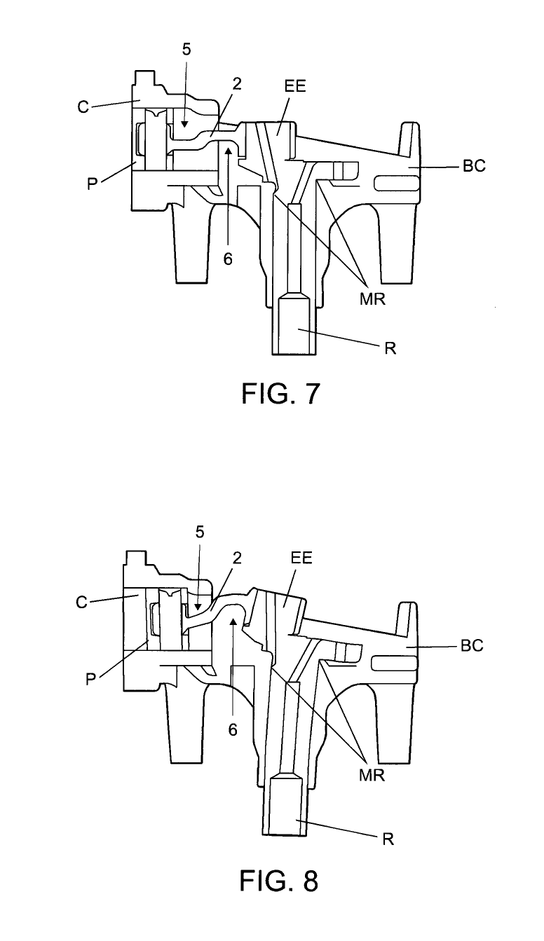

FIGS. 2 and 3 illustrate two exemplary rod of the present invention. In both given examples, the rod 1 is mainly comprised of a body 2, a first connecting end 3 and a second connecting end 4. It is observed that the connecting ends 3, 4 are physically associated with the body 2.

Therefore, it is worth to clarify that the rod 1 (although described as containing distinct parts) comprises an entire monoblock, which is preferably made of metal alloy.

The body 2 comprises preferably a rectangular cross section body (non-limiting feature), and connecting the ends 3, 4 comprise eyelets circular connection. In particular, the first connecting end 3 is intended for connecting with a piston P, while the connecting end 4 is intended for connecting to an eccentric axis EE, which is linked to an engine rotor R (not shown).

Therefore, and as for the knowledge of experts skilled in the art, the circular motion of the rotor R is converted—by the rod 1—into linear motion for the piston P.

The great advantage of the rod 1 relatively to functionally similar rods and belonging to the current state of the art relates to the fact that said rod 1 (regardless of exemplary illustration) comprises means for compensating deflection efforts and ensure alignment of the piston P inside the cylinder C, where such means comprise at least two regions 5, 6 capable of oriented resilient deformation.

Said regions 5, 6 capable of resilient deformation are formed oriented in the body 2, in particular, the distal ends of the body 2, and each of the regions 5, 6 capable of resilient deformation is guided between the distal ends the body 2 and its connection to said end 3, 4.

According to the concepts of the present invention, the regions 5, 6 of rod 1 are capable of oriented resilient deformation in opposite directions, i.e., while the fifth region (near the connecting end 3) is deformable “up” (connecting end 3 tends to “rise”), region 6 (near the connecting end 4) is deformable “down” (the connecting end 4 ends to “down”).

Therefore, the regions 5, 6 capable of oriented resilient deformation comprise each a curvature or a relief area formed in the body 2, and at least one of the regions 5, 6 capable of oriented resilient deformation has its vertex vertically upwards and at least one of the regions 5, 6 capable of oriented resilient deformation has its vertex vertically downwards.

FIGS. 4 and 5 illustrate the “performance” of rod 1 in a reciprocating compressor which is schematically represented by a compressor block CB and a rotor R. Such reciprocating compressor is (but is not limited) a medium-capacity compressor, which provides only lower bearings MR for the rotor.

FIG. 4 illustrates the minimum compression load of the compressor, where the piston P is at the final “end” of the cylinder C (onset of sucking process). In this situation, it is noted that the connecting rod 1 suffers a virtually zero deflection and/or non-relevant effort. Therefore, no area of the rod 1 is deformed, and the piston P is perfectly aligned respect to the inner face of the cylinder C.

FIG. 5 illustrates the maximum compressive load, where the piston P is at the end “intermediate” of the cylinder C (end of suction/compression process). In this situation, it is noted that the rod 1 undergoes a major virtually possible deflection effort. In this case, the regions 5, 6 capable of oriented resilient deformation (because the regions are the more “flexible” of rod 1, and because they had a bend or a relief area which facilitates oriented resilient deformation) are deformed, and their curvatures are so remarkable that the connecting end 3 tends to “rise” and the connecting end 4 tends to “descend”.

Within this context, the term “oriented resilient deformation” due to the fact that the “deformation” occurs only in certain situations, being sometimes the rod 1 is deformed (maximum compressive load), and sometimes the rod 1 is in natural conformation. Thus, it can be stated that the deformation is resilient as the rod always tends to return to its normal state (without deformation).

Moreover, one can consider the “deformation” is guided by the fact that it dedicatedly occurs just in regions 5, 6.

These oriented deformations, even though in the order of micrometers, allow alignment of the piston P, relative to the inner face of the cylinder C be maintained. In addition to ensuring alignment, these deformations are oriented to compensate the deflection efforts generated during compression of a working fluid.

Indirectly these benefits (keeping the alignment of the piston P, relative to the inner face of the cylinder C and to compensate for deflection efforts generated during the compression of a working fluid) allow the compressor with medium capacity constructive characteristics (free of high bearing rotor), provided that it uses the connecting rod 1 disclosed in the present invention, could provide a compressive capability similar to high-capacity compressor (rotor with bearings symmetrically opposite upper and lower piston connecting rod axis), after all, it is possible to increase the volumetric displacement (and therefore, generated deflection efforts during compression of a working fluid) without piston P, cylinder C and eccentric axis EE suffer damage and excessive wear.

Having described specific examples of the rod reciprocating compressor disclosed herein, it should be understood that the scope of the present invention encompasses other possible variations, which are limited solely by the scope of appended claims, where the possible equivalent arrangements are included.

1. The connecting rod of a reciprocating compressor of the type which converts a circular motion from an eccentric axis (EE) into reciprocating linear movement to a piston (P), comprising a first connecting end (3) and a second connecting end (4), both physically associated by a body (2); wherein the rod (1) comprises:
means able to compensate deflection efforts and ensure alignment of the piston (P) inside the cylinder (C);
means able to compensate deflection efforts and ensure alignment and of the piston (P) inside the cylinder (C) comprising at least two regions (5, 6) capable of oriented resilient deformation;
regions (5, 6) capable of oriented resilient deformation being shaped in the body (2) and
regions (5, 6) being capable of oriented resilient deformation in opposite directions.

2. A reciprocating compressor connecting rod, according to claim 1, wherein each regions (5, 6) capable of oriented resilient deformation is in a distal end of the body (2).

3. A reciprocating compressor connecting rod, according to claim 2, wherein each regions (5, 6) capable of guided resilient deformation is between one of distal ends of the body (2) and its said connection end (3, 4).

4. A reciprocating compressor connecting rod, according to claim 1, wherein the regions (5, 6) capable of oriented resilient deformation comprise each one a curvature conformed in the body (2).

5. A reciprocating compressor connecting rod, according to claim 1, wherein the regions (5, 6) capable of oriented resilient deformation, comprise each one a relief area formed in the body (2).

6. A reciprocating compressor connecting rod, according to claim 4, wherein:
at least one of the regions (5, 6) capable of resilient deformation has its apex oriented vertically upwards, and
at least one of the regions (5, 6) capable of resilient deformation has its apex oriented vertically downwards.
